(19) United States
(12) Patent Application Publication
(10) Pub. No.: US 2005/0097347 A1
(43) Pub. Date: May 5, 2005

(54) Printer security key management

(76) Inventors: Mark M. Josephsen, Boise, ID (US); Curtis Rees, Boise, ID (US); Shane Konsella, Star, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/700,075

(22) Filed: Nov. 3, 2003

(51) Int. Cl. H04L 9/00

(52) U.S. Cl. 713/200

(57) ABSTRACT

A printer module receives a message from an attached computer that is requesting a secure printing key. The printer module generates a key in response to the received message, and sends the key to the attached computer requesting the key. The printer module executes in some embodiments of the invention in a Java virtual machine, and provides communication with the attached computers via a web server module executing within the printer.

### FIELD OF THE INVENTION

The invention relates generally to secure printing, and more specifically to a printer having encryption key management capability.

### BACKGROUND OF THE INVENTION

Printers typically print a document received from an attached computer upon receipt of the digital information representing the document to be printed. Multiple users may be electronically attached to the same printer via a network, so that a single printer is used by several people. In some environments, printers can receive data to be printed by other means also, including via a wireless or infrared network rather than via a wired network.

When several users or computer systems share access to a single printer, the printed documents are usually printed in the order they are sent to the printer, and left to be retrieved by the person printing each specific document. This system works adequately for environments in which the content of the printed documents is not secret or confidential, but works less well where the person printing a document may not want others who have physical access to the printer or use the same network to access the printed data.

One solution is to set up a mailbox on a shared printer that receives a matter, but does not print it until the user owning the mailbox enters a pin number or other identifier indicating that they are present at the printer. This enables the person printing the document to retrieve the pages as they are printed, even when the printer is not located near the computer that was used to print the document.

Although this solution prevents those sharing a printer from intercepting and reading documents printed by other users, it may not prevent those sharing the same network from intercepting or monitoring the network for print data and reading the data. Although this is beyond the ability of the average office worker, it is a real threat in environments such as banking, human resources, government, and other such businesses that deal with particularly sensitive or confidential information.

There exists a need for methods and systems that address the security of such sensitive or confidential data.

### SUMMARY OF THE INVENTION

In one example embodiment of the invention, a printer module receives a message from an attached computer that is requesting a secure printing key. The printer module generates a key in response to the received message, and sends the key to the attached computer requesting the key. The printer module executes in some further embodiments of the invention in a Java virtual machine, and provides communication with the attached computers via a web server module executing within the printer.

### BRIEF DESCRIPTION OF THE FIGURES

FIG. 1 shows a printer and attached computer system consistent with one embodiment of the present invention.

FIG. 2 is a flowchart illustrating a method of practicing one embodiment of the present invention.

### DETAILED DESCRIPTION

In the following detailed description of sample embodiments of the invention, reference is made to the accompanying drawings which form a part hereof, and in which is shown by way of illustration specific sample embodiments in which the invention may be practiced. These embodiments are described in sufficient detail to enable those skilled in the art to practice the invention, and it is to be understood that other embodiments may be utilized and that logical, mechanical, electrical, and other changes may be made without departing from the scope of the present invention. The following detailed description is, therefore, not to be taken in a limiting sense, and the scope of the invention is defined only by the appended claims.

The present invention provides a printer module that in some embodiments is operable to receive a message from an attached computer that is requesting a secure printing key. The printer module generates a key in response to the received message, and sends the key to the attached computer requesting the key. The printer module executes in some further embodiments of the invention in a Java virtual machine, and provides communication with the attached computers via a web server module executing within the printer.

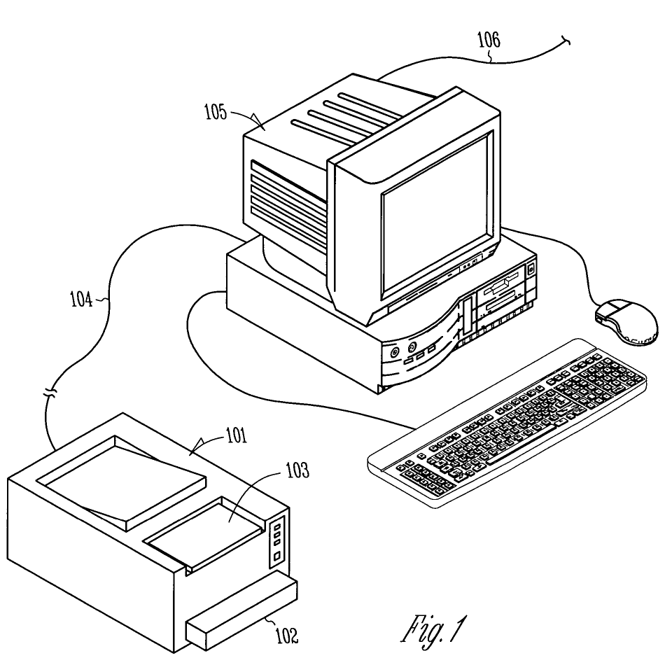

FIG. 1 shows an example system upon which some embodiments of the present invention may be practiced. A printer device 101 prints received data on paper or other media for physically recording the data. The typical laser printer illustrated here, for example, processes paper from paper tray 102 and deposits toner from toner cartridge 103 on the paper to create a physical record of the data to be printed. Various other printers include inkjet, dye sublimation, and ribbon impact marking technology, and print on various media such as transparencies, envelopes, and photographic paper.

The printer 101 is here connected via connection 104 to a computerized system 105. The connection 104 in various embodiments of the invention comprises any of various types of connection operable to provide communication between the computer and printer, including parallel (IEEE 1284), Universal Serial Bus (USB), firewire (IEEE 1384), ethernet, and other such connections. The computerized system is further attached to a network such as network 106, and is employed by a user, who wishes access to the printer 101 for printing data.

In operation, the user of the computerized system 105 requests to send a document to the printer 101 using secure printing features of the printer. More specifically, the user first requests that the printer 101 generate encryption or security keys for use in encrypting data sent from the computerized system to the printer. A module within the printer receives the message requesting the secure printing key, generates the key, and sends the key to the user's computerized system 105 via connection 104. The computerized system 105 then stores the key, and uses it to encrypt data sent to printer 101 so that even if the document is intercepted over connection 104 the document cannot be easily interpreted or understood.

In some embodiments of the invention, the user requests the security key by accessing a web page hosted by a web server within the printer 101. In a further embodiment, the printer 101 executes the security module operable to generate and send keys in a Java virtual machine executing within the printer 101.

Generation of the security keys within the security module will take different forms in various embodiments of the invention. In one embodiment, a symmetric key is generated, and the symmetric key is transmitted to the attached computer requesting the key via connection 104 only after a secure connection has been negotiated between printer 101 and computer 105. This ensures the confidentiality of the symmetric key, which can be used to encrypt data or to decrypt data that has already been encrypted with the same symmetric key. A wide variety of algorithms using symmetric keys or block ciphers, including DES (Data Encryption Standard), IDEA, CAST, Twofish, Blowfish, MD5, and RC5, may be employed in this manner in various embodiments to ensure the confidentiality of data between the computerized system 105 and the printer 101.

In other embodiments of the invention, asymmetric algorithms may be employed, such as the public key/private key RSA system. In the public key/private key systems, the printer security module generates both a public and a private key. It retains the private key, and sends the public key to the computerized system 105. The public key can be used to encrypt data sent to the printer, but cannot be used to decrypt the encrypted data. This means that if the public key is sent to the requesting user of the computerized system 105 over an insecure link, the person intercepting the public key cannot decrypt data cannot use the key to decrypt data sent from the computerized system 105 to the printer 101, but can only encrypt data sent to the printer 101 as though he were the authorized user of the public key.

When the printer receives the data encrypted by the public key, it decrypts it using the private key, and either prints the data or stores the data until the user indicates he is ready for the data to be printed. Storing the data until the user confirms it is to be printed is useful in applications where a single printer is shared among many users or is located in a relatively public place. The user can then identify himself to the printer such as by entering a pin number, and cause the document to print when he is at the printer and able to ensure the physical security of the printed data.

Interception of data sent to the printer 101 from the computerized system 105 is a particularly significant risk when the connection 104 is a network connection, such as an ethernet network or an internet connection. In applications such as human resources management, banking, or national defense, it is often important that the printed data not be intercepted or viewed by unauthorized people, and that it not be altered. Encryption prevents viewing or altering data, and so is employed to ensure the security of the transmitted data.

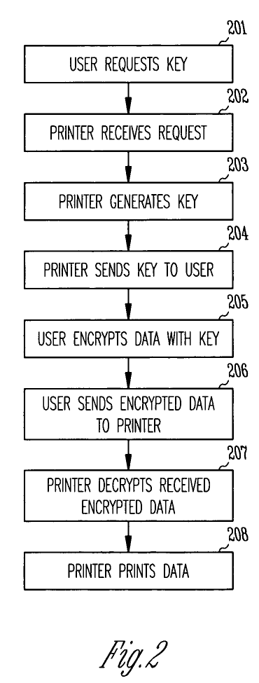

(FIG. 2 is a flowchart illustrating a method of managing security keys within a printer, consistent with an embodiment of the present invention.) Duplicate?

FIG. 2 is a flowchart, showing a method of practicing one embodiment of the present invention. A user wishing to use a printer connected to a network first identifies the printer and requests a key from the printer at 201. The key is requested in some embodiments via a web browser interface, via the printer driver, or via other methods. The printer receives the key request at 202, and sends the request to the security module within the printer to produce a key at 203. The generated key in various embodiments of the invention may be a symmetric key, may be a public key that is a part of a public key/private key pair of generated keys, or may be another type of encryption or security key.

The generated key is then sent to the user's computerized system at 204, over what is desirably a secure connection between the printer and the computerized system in embodiments using symmetric encryption keys. The user can then use the received key to encrypt data to be printed at 205, so that when the data is sent to the printer at 206 it is sent in encrypted form that cannot be easily viewed or altered if it is intercepted.

When the printer receives the encrypted data, it uses its security key to decrypt the data at 207, and is then able to print the decrypted data at 208. In some further embodiments of the invention, the printer prints the data only after the user indicates physical presence at the printer, such as by entering a pin number or password, to further protect the physical security of the printed document.

The system presented here does not require a central key management authority, even for embodiments that use a public key/private key encryption algorithm, because the printer acts as its own trusted key management authority. Incorporation of key production and management functions into a security module within the printer provides a simpler system of key management, and a web browser-based interface to the security module provides users with a user-friendly interface to perform key management functions. Further embodiments of the invention will provide a variety of key management functions, including the ability to create, assign, delete, group, or otherwise manage the keys and users as is deemed appropriate for a particular application.

Although specific embodiments of a printer security key distribution system have been illustrated and described herein, it will be appreciated by those of ordinary skill in the art that any arrangement which is calculated to achieve the same purpose may be substituted for the specific embodiments shown. This application is intended to cover any adaptations or variations of the invention. It is intended that this invention be limited only by the claims, and the full scope of equivalents thereof.

1. A security module within a printer that is operable to:
receive a message from an attached computer requesting a secure printing key;
generate a key in response to the received message; and
send the key to the attached computer requesting the key.

2. The security module of claim 1, wherein the generated key comprises a symmetric encryption key.

3. The security module of claim 2, wherein the sending the key to the attached computer requesting the key comprises sending the key to the attached computer over a secured connection.

4. The security module of claim 1, wherein the symmetric key is a DES key.

5. The security module of claim 1, wherein generating a key comprises generating a public key and a private key, and wherein sending the key to the attached computer requesting the key comprises sending the public key to the attached computer requesting the key.

6. The security module of claim 5, wherein the public key is sent to the attached computer over a secured connection.

7. The security module of claim 1, wherein the security module receives the message from an attached computer via a web server hosted within the printer.

8. The security module of claim 1, wherein the security module executes within a Java virtual machine within the printer.

9. The security module of claim 1, wherein the attachment between the printer and the attached printer is a network attachment.

10. A machine-readable medium with instructions stored thereon, the instructions when executed operable to cause a computerized printer to:
receive a message from an attached computer requesting a secure printing key;
generate a key in response to the received message; and
send the key to the attached computer requesting the key.

11. The machine-readable medium of claim 10, wherein the generated key comprises a symmetric encryption key.

12. The machine-readable medium of claim 11, wherein the sending the key to the attached computer requesting the key comprises sending the key to the attached computer over a secured connection.

13. The machine-readable medium of claim 10, wherein the symmetric key is a DES key.

14. The machine-readable medium of claim 10, wherein generating a key comprises generating a public key and a private key, and wherein sending the key to the attached computer requesting the key comprises sending the public key to the attached computer requesting the key.

15. The machine-readable medium of claim 14, wherein the public key is sent to the attached computer over a secured connection.

16. The machine-readable medium of claim 10, wherein the security module receives the message from an attached computer via a web server hosted within the printer.

17. The machine-readable medium of claim 10, wherein the security module executes within a Java virtual machine within the printer.

18. The machine-readable medium of claim 10, wherein the attachment between the printer and the attached printer is a network attachment.

19. A peripheral device module executable within the computerized peripheral device that when executed is operable to:
receive a message from an attached computer requesting a secure printing key;
generate a key in response to the received message; and
send the key to the attached computer requesting the key.

20. A computer printer system, comprising:
receive a message from an attached computer requesting a secure printing key;
generate a key in response to the received message; and
send the key to the attached computer requesting the key.

21. A method of managing a printer in a computerized system external to the printer, comprising:
receive a message from an attached computer requesting a secure printing key;
generate a key in response to the received message; and
send the key to the attached computer requesting the key.
